(19) United States
(12) Patent Application Publication
(10) Pub. No.: US 2010/0290966 A1
(43) Pub. Date: Nov. 18, 2010

(54) METHOD AND APPARATUS FOR THE REMOVAL OF FLUORINE FROM A GAS STREAM

(76) Inventor: Andrew James Seeley, Bristol (GB)

Correspondence Address: Edwards Vacuum, Inc., 2041 MISSION COLLEGE BOULEVARD, SUITE 260, SANTA CLARA, CA, 95054, US

(21) Appl. No.: 12/303,776

(22) PCT Filed: May 23, 2007
(86) PCT No.: PCT/GB07/50285

§ 371 Date: May 19, 2010

(51) Int. Cl. B01D 53/68; B01D 53/54

(52) U.S. Cl. 423/239.1; 423/240 R; 423/241

(57) ABSTRACT

A method for the removal of a fluorinated gas from a gas stream (1) comprising the steps of: conveying the gas stream (1) containing the fluorinated gas to a combustion region (2), decomposing the fluorinated gas in the combustion region (2), entraining a calcium salt (4) capable of reacting with the fluorinated gas decomposition products into the gas stream to react with the fluorinated gas decomposition products to form calcium fluoride and then removing (10) the calcium fluoride salt from the gas stream.

The present invention is concerned with the removal of fluorine from a gas stream, and finds particular use in the removal of fluorine from fluorine containing gases exhausting from a process tool used in the semiconductor or flat panel industry.

CF₄, C₂F₆, NF₃, SF₆ and molecular fluorine (F₂) are commonly used as etchant precursor gases in the semiconductor and flat panel industry to provide a source of excited fluorine species for processes such as dielectric layer etching and chamber cleaning.

In most cases excited fluorine species such atomic fluorine are formed in situ, or upstream of a chamber, to react with unwanted deposits and form volatile fluorinated compounds that are easily pumped away. However, gas use during these steps is often inefficient and so the effluent gas stream from the tool can have a residual amount of either the fluorinated pre-cursor gas or a range of other gaseous fluorinated reaction by-products.

Due to their toxicity and/or extremely high global warming potential any unused fluorinated gases and fluorinated reaction by-products must be removed (abated) from the chamber exhaust gas mixture prior to its release to the atmosphere. At present abatement is commonly carried out by combustive techniques, in devices such as inwardly fired burners, electrically heated burners, open flame burners or plasma abatement devices. In these devices the exhaust gases from the process chamber pass to a reactive zone where there is sufficient energy and reactive species, in the form of heat and fuel/oxidant gases respectively, to effect the conversion of the fluorinated gases to hydrofluoric acid (HF).

To meet stringent emission targets the hydrofluoric acid must then be removed from the gas stream, which is often achieved with wet scrubbers. These require large volumes of water to dissolve the HF, which is subsequently removed from the water by reaction with calcium salts as a calcium fluoride precipitate (CaF₂). The precipitate is separated from the water by settling and “caking” allowing the water to be reused or passed to the sewerage system. The hydrofluoric acid may also be removed by passing the exhaust gases from the combustive destruction device through a dry reactive bed of Calcium salts, which are often inefficient due to the formation of a calcium fluoride layer on the surface of the bed, rendering it impervious to further reaction.

It is the intention of the invention described herein to address some of these problems.

In the first aspect the invention provides a method for the removal of a fluorinated gas from a gas stream comprising the steps of: conveying the gas stream containing the fluorinated gas to a combustion region, decomposing the fluorinated gas in the combustion region, entraining a calcium salt capable of reacting with the fluorinated gas decomposition products into the gas stream to react with the fluorinated gas decomposition products to form calcium fluoride, and then removing the calcium fluoride salt from the gas stream.

This provides a new method for the removal of fluorinated gases such as molecular fluorine (F₂) and perfluorinated gases (for example nitrogen trifluoride (NF₃), carbon tetrafluoride (CF₄), hexafluoroethane (C₂F₆), silicon tetrafluoride (SiF₄), and sulphur hexafluoride (SF₆)) from a gas stream. The method advantageously reduces the requirement for expensive multi stage water treatment methods or inefficient dry bed reactors to remove the fluorinated decomposition (abatement) products from the gas stream on exiting the combustion region.

The combustion region is preferably, but not limited to, that of devices such as inwardly fired burners, electrically heated burners, open flame burners, DC plasmas and microwave plasma reactors. Such devices, already widely used for the destruction (abatement) of fluorinated gases, could advantageously be retro fitted with calcium fluoride entrainment devices, thus allowing the user to save energy without the need for large additional capital expenditure.

The calcium salts may be entrained into the gas stream containing the fluorinated gas prior to it entering the combustion region; when it is inside the combustion region; or when it has exited the combustion region. The calcium salts are preferably entrained in the gas stream either inside or close to the exit of the combustion region as the thermal conditions present enhance the reaction between the calcium salt and the fluorinated gas decomposition products.

The calcium salts may be entrained into the gas stream containing the fluorinated gas using many of the methods know to the skilled person such as air blown powder techniques, atomising spray techniques, simple spraying techniques and vaporisation techniques.

A carrier gases may be also used to entrain the calcium salt into gas stream including air, nitrogen, hydrogen, oxygen, methane, butane. The use of either a reducing or oxidising carrier gas can advantageously improve the reaction between the calcium salts and fluorinated decomposition products.

The calcium salt or its decomposition products must be able to react with the fluorinated decomposition products formed in the combustion region to form calcium fluoride, preferably without producing substantial quantities of undesirable additional gaseous by-products such as acids or NOx that would require further expensive scrubbing techniques. Examples of suitable calcium salts include, for example, CaO (Lime), CaCO₃, Ca(OH)₂ (Slaked Lime), and organo-calcium salts such as Ca(CH₃CH₂CO₂)₂.H₂O. The calcium fluoride, which can then be removed from the gas stream by one or a combination of filter, cyclone and electrostatic precipitator devices. In apparatus where an atomising, or simple spraying technique are favoured it is preferable to use calcium acetate, Ca(CH₃CH₂CO₂)₂.H₂O, as it readily forms a concentrated aqueous solution, thus maximising the amount of calcium and limiting the amount of water supplied to the apparatus and ensuring that the calcium fluoride salt, formed by reaction with the fluorinated gas decomposition products, remains substantially dry.

The removal of calcium fluoride from the gas stream can be carried out either in-situ by a device local to the combustion device or by a scrubber unit situated remotely from the combustion device, which allows the calcium fluoride from several combustion devices to be removed in a centralised area thus minimising the risk of particulate contamination of the ultra clean semiconductor processing areas.

Preferred features of the present invention will now be described by way of example with reference to the accompanying drawings, in which:

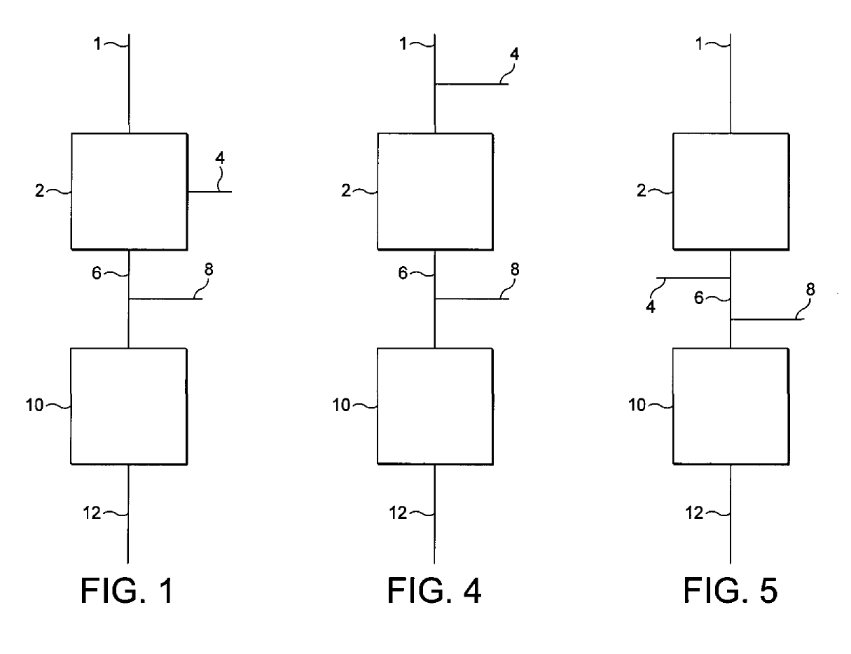

FIG. 1 illustrates a first schematic for the removal of fluorinated gas from a gas stream.

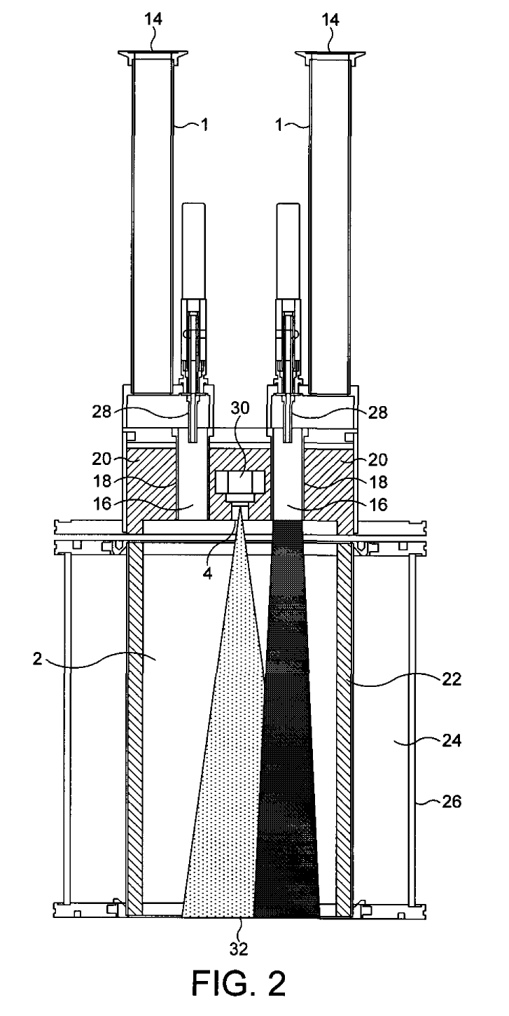

FIG. 2 shows an embodiment of the schematic illustrated in FIG. 1

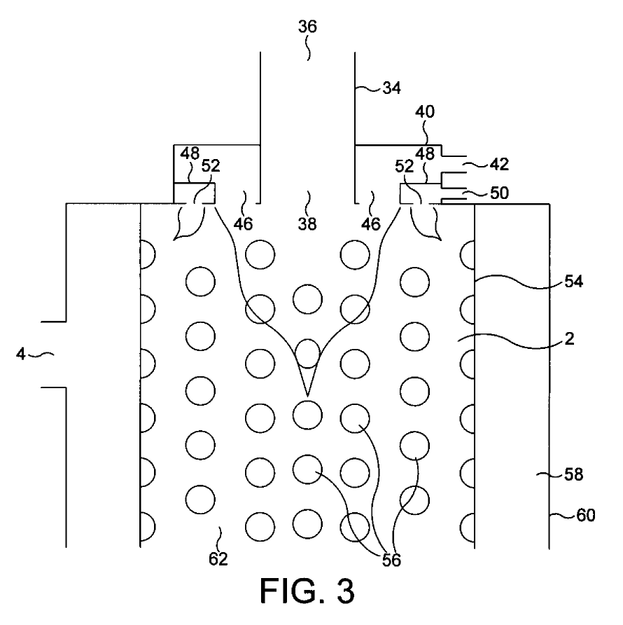

FIG. 3 shows a further embodiment of the schematic illustrated in FIG. 1

FIG. 4 illustrates a second schematic for the removal of fluorinated gas from a gas stream.

FIG. 5 illustrates a third schematic for the removal of fluorinated gas from a gas stream.

The drawings are not to scale

Like parts in different Figures are referred to below by the same reference numeral.

FIG. 1 illustrates schematically an apparatus for the removal of fluorinated gas from a gas stream. The apparatus comprises path 1 for conveying gas stream or streams containing fluorinated gas, for example, pumped from a semiconductor or flat panel display process tool by means of a vacuum pumping system (not shown) to combustion region 2. Combustion region 2 may be, for example, that of an inwardly fired burner, electrically heated burner, open flame burner, DC plasma or microwave plasma reactor, wherein the fluorinated gas is converted (abated) to HF. Combustion region 2 also comprises inlet 4 for entraining a calcium salt, for example one of, calcium oxide, slaked lime, calcium carbonate and calcium acetate, into the gas stream within combustion region 2. The calcium salt, dependent on its particular composition, may be entrained into the gas stream in combustion region 2 as a solution, powder or vapour by methods well known in the art, such as air blown powder methods, atomising spray methods and vaporisation methods. The calcium salt can be directly entrained into the gas stream in the combustion region or alternatively first entrained into an additional carrier gas stream, which is then supplied to the gas stream in the combustion region 2 via inlet 4. The calcium salt, or its decomposition products, reacts with the HF in the combustion region to form calcium fluoride.

Path 6 conveys the calcium fluoride-rich gas stream exiting the combustion region 2 to calcium fluoride removal device or devices 10 in which the calcium fluoride is removed from the gas stream, with a calcium fluoride lean gas stream exiting the removal device 10 via path 12. Removal device 10 may be, for example, a cyclone, filter and electrostatic precipitator, or combinations thereof.

In order to both remove heat from the gas stream exiting the combustion region 2 and ensure that the calcium fluoride remains airborne, and is therefore prevented from collecting on the surfaces of the apparatus upstream of the removal device 10, an optional flow gas, such as air, oxygen or nitrogen, may be supplied to path 6 via inlet 8.

FIG. 2 shows a preferred embodiment of the abatement section of the schematic apparatus illustrated in FIG. 1. The apparatus comprises one or more inlets 14 for receiving an effluent gas stream or streams containing fluorinated gas. The effluent gas stream or streams containing the fluorinated gas are conveyed along paths 1 to nozzles 16 from which the effluent stream is injected into combustion region 2. In the illustrated embodiment two inlets 14 are shown for receiving two effluent gas streams containing fluorinated gas from two pumping systems connected to, for example, two process chambers. Alternatively the effluent gas stream from a chamber may be “split” and conveyed to each of the inlets 14. The preferred embodiment comprises four inlets 14.

Each nozzle 16 is located within a respective bore 18 formed in a ceramic top plate 20, which defines the upper (as shown) surface of the combustion region 2. The combustion region 2 is within the bounds of the exit surface of a foraminous burner element 22 such as that described in EP-A-0 694 735. A plenum volume 24 is formed between the burner and a cylindrical outer shell 3. A mixture of fuel gas such as natural gas, or hydrocarbon, and air is introduced into the volume245 via one or more inlet nozzles (not shown) so that, during use, the mixture of fuel gas and air will burn without visible flame at the exit surface of burner element 22.

In order to optimize combustion conditions to achieve abatement of the particular fluorinated gas contained within the effluent gas stream it is preferable to supply additional fuel gas and/or oxygen to enrich the effluent stream prior to its entry into the combustion region 2. Therefore the apparatus includes means, by way of a lance 28 substantially concentrically positioned within the nozzle 16, for introducing oxygen into the effluent stream upstream of the combustion region 2, similar to that described in EP 0 802 370 A2. Additional fuel gas may be added by any suitable means (not shown) to the effluent gas stream at any convenient point upstream of the combustion region. However, for reasons of flammability, the oxygen and fuel gas should not be present in the effluent stream for any appreciable length of time prior to their injection to the combustion zone, and so the opening of the lance 28 into the nozzle 16 terminates between 0.7 and 3 pipe diameters prior to the point of injection of the effluent into the combustion region. The relative proportions of fuel gas and/or oxidant may be varied dependent on the type of fluorinated compounds present in the effluent stream.

Upon injection into the region 2 the enriched effluent gas mix ignites to form a flame extending from the nozzle 16 into the chamber 2 effecting the abatement of fluorinated gases by the general formula:

Fluorinated gas+Fuel+Oxygen→HF+CO/CO₂ and H₂O (1)

The apparatus also comprises one or more calcium fluoride entrainment devices 30, preferably an atomising spray device although other entrainment devices are also suitable, located within ceramic top plate 20. The calcium fluoride is entrained into the gas stream in the combustion region, by any of the aforementioned means, via inlet 4. The entrainment device/or devices 30 and their corresponding inlets 4 are positioned such that sufficient mixing of the entrained calcium fluoride and effluent gas stream occurs in the combustion region 2 without inhibiting the flame extending from the nozzle 16 into the region 2. Upon entrainment into the gas stream in region 2 the calcium salt, or its decomposition products, reacts with hydrofluoric acid from the abatement of the fluorinated gases to form calcium fluoride by the general formula:

HF+Calcium salt→CaF₂ (2)

The gas stream and calcium fluoride then exit the abatement apparatus via exit 32 and are conveyed to one of the aforementioned device or devices 10 for the removal of the calcium fluoride from the gas stream.

FIG. 3 shows a further preferred embodiment of the abatement section of the schematic apparatus illustrated in FIG. 1. The apparatus comprises one or more combustion nozzles 34 connected to a combustion region 2, similar in construction and use to those described in EP-A-0 819 887. Each combustion nozzle 34 has an inlet 36 for receiving effluent gas containing fluorinated gas, and an outlet 38 from which the exhaust gas enters combustion region 2. Whilst FIG. 3 illustrates a single combustion nozzle 34 for receiving the effluent gas containing a fluorinated gas, the apparatus may comprise any suitable number, for example four, six or more, nozzles 34 for receiving the effluent from a single or multiple process tools. In the preferred embodiments, the apparatus comprises four nozzles 34.

As illustrated in FIG. 3, each nozzle 34 is mounted in a first annular plenum chamber 40 having an inlet 42 for receiving a first gas mixture of fuel and oxidant, for example, a mixture of methane and air, providing a combustion gas for forming combustion flames within the combustion region 2, and a plurality of outlets 46 from which the combustion gas exits the plenum 40 into the combustion chamber 2. As illustrated in FIG. 3, the combustion nozzle 34 is mounted in the first plenum chamber 40 such the nozzle 34 passes substantially co-axially through a respective outlet 46 and that the first combustion gas mixture is conveyed into the combustion chamber 2 about the combustion nozzles 34.

As also illustrated in FIG. 3, the first plenum chamber 40 is located above a second annular plenum chamber 48 having an inlet 50 for receiving a second, pilot gas mixture of fuel and oxidant, for example, another mixture of methane and air, for forming pilot flames within the combustion chamber 2. As illustrated in FIG. 3, the second plenum chamber 48 comprises second apertures 52 surrounding the first apertures 46 from the first plenum chamber 40. The second apertures 52 allow the pilot gas mixture to enter the combustion chamber 2 to form the pilot flame for igniting the combustion gas entering the combustion region 2 via apertures 46 to form combustion flames within the combustion chamber 2.

The first combustive gas mixture exiting apertures 46 is ignited by the pilot flame, formed from the second pilot gas mixture exiting apertures 52, to form a combustion flame extending into the combustion region 2 concentrically surrounding the path of the effluent gas stream exiting the nozzle 34. The effluent gas stream conveyed through the nozzle 34 enters the combustion region 2 via outlet 38 into the center of the combustion flame such that the fluorinated gases are abated according to the general formula (1) above.

The combustion chamber 2 is within the bounds of a substantially cylindrical conduit 54. The conduit 54 has a plurality of apertures 56 through which gas can pass from plenum chamber 58 formed between the conduit 54 and an outer shell 60. A suitable calcium fluoride entrainment device, preferably an air blow powder device or atomising spray device (not shown), although other entrainment devices are also suitable, is used to entrain a calcium salt into a gas stream, for example air, which is fed into the plenum chamber 58 via inlet 4. The calcium salt enriched gas enters combustion region 2 via apertures 56. The calcium salt, or its decomposition products, then reacts with the HF to form calcium fluoride according to the general formula 2 above. The effluent stream and calcium fluoride then exit the combustion region 2 via exit 62 and are conveyed from the abatement device to one of the aforementioned device or devices 10 for the removal of the calcium fluoride from the gas stream.

FIG. 4 illustrates schematically a second apparatus for the removal of fluorinated gas from a gas stream. The apparatus is substantially similar to that illustrated in FIG. 1, however the inlet 4 for entraining calcium salt into the gas stream is positioned in path 1 so that the calcium salt is entrained into the gas stream containing fluorinated gas prior to it being conveyed into the combustion chamber 2.

In use of the apparatus shown schematically in FIG. 4 an effluent gas stream containing a fluorinated gas is conveyed along path 1 wherein a calcium salt is entrained into the gas stream, using any of the aforementioned means, via inlet 4. The gas stream containing the fluorinated gas and calcium fluoride is conveyed to combustion region 2 wherein the fluorinated gas is abated to form HF which reacts with the calcium salt or its decomposition products to form calcium fluoride. The gas stream containing the calcium fluoride is then conveyed from the combustion region 2, along path 6, to one of aforementioned calcium fluoride removal device or devices 10, wherein the calcium fluoride is removed from the gas stream which then exits the calcium fluoride removal device via path 12.

A carrier gas, for example, air, oxygen and nitrogen may be optionally added via inlet 8 to the gas stream conveyed along path 6 to encourage the calcium fluoride to stay airborne until it reaches calcium fluoride removal device 10.

FIG. 5 illustrates schematically a third apparatus for the removal of fluorinated gas from a gas stream. The apparatus is substantially similar to that illustrated in FIGS. 1 and 4, however inlet 4 for entraining calcium salt into the gas stream is positioned in path 6 so that the calcium salt is entrained into the gas stream exiting combustion chamber 2.

In use of the apparatus shown schematically in FIG. 3 a gas stream containing a fluorinated gas is conveyed along path 1 to combustion region 2, wherein the fluorinated gas is abated. The gas stream containing the fluorinated gas decomposition products is conveyed away from combustion region 2 via path 6 wherein a calcium salt is entrained into the gas stream via inlet 4, enabling the calcium salt or its decomposition products to react with the fluorinated gas decomposition products to form calcium fluoride. The gas stream containing the calcium fluoride is then conveyed further along path 6, to the calcium fluoride removal device or devices 10, wherein the calcium fluoride is removed from the gas stream which then exits the calcium fluoride removal device via path 12.

A carrier gas, for example, air, oxygen and nitrogen may be optionally added to the gas stream conveyed along path 6 via inlet 8, downstream of inlet 4, to encourage the calcium fluoride to stay airborne until it reaches calcium fluoride removal device 10. The carrier gas may also be added with the calcium fluoride via inlet 4.

1. A method for the removal of a fluorinated gas from a gas stream comprising the steps of:
conveying the gas stream containing the fluorinated gas to a combustion region,
decomposing the fluorinated gas in the combustion region,
entraining a calcium salt capable of reacting with the fluorinated gas decomposition products into the gas stream to react with the fluorinated gas decomposition products to form calcium fluoride and
removing the calcium fluoride salt from the gas stream.

2. The method according to claim 1 wherein the fluorinated gas comprises molecular fluorine (F₂) or a mixture of molecular fluorine (F₂) and the perfluorinated gases.

3. The method according to claim 2 wherein the perfluorinated gases comprise at least one gas selected from the group consisting of nitrogen trifluoride (NF₃), carbon tetrafluoride (CF₄), Hexafluoroethane (C₂F₆), Silicon tetrafluoride (SiF₄), and Sulphur hexafluoride (SF₆) and mixtures thereof.

4. The method according to claim 1 wherein the calcium salt comprises at least one compound selected from the group consisting of CaO, CaCO₃, Ca(OH)₂, Lime, Slaked Lime and Ca(CH₃CH₂CO₂)₂H₂0 and mixtures thereof.

5. The method according to claim 1 comprising the step of entraining the calcium salt into the gas stream downstream of the combustion region

6. The method according to claim 1 comprising the step of entraining the calcium salt into the gas stream inside the combustion zone

7. The method according to claim 1 comprising the step of entraining the calcium salt into the gas stream upstream of the combustion zone

8. The method according to claim 1 comprising the step of entraining the calcium salt into the gas stream by an air blown powder technique

9. The method according to claim 1 comprising the step of entraining the calcium salt into the gas stream by a simple spraying technique

10. The method according to claim 1 comprising the step of entraining the calcium salt into the gas stream by an atomising spray technique

11. The method according to claim 1 wherein the combustion region comprises an inwardly fired burner.

12. The method according to claim 1 wherein the combustion region comprises an electrically heated burner.

13. The method according to claim 1 wherein the combustion region comprises an open flame burner.

14. The method according to 1 wherein the combustion region comprises a plasma reactor.

15. The method according to claim 1 comprising the step of removing the calcium fluoride salt from the gas stream by at least one removal device selected from the group consisting of a filter, a cyclone and electrostatic precipitator.
